(19) United States
(12) Patent Application Publication
(10) Pub. No.: US 2012/0169279 A1
(43) Pub. Date: Jul. 5, 2012

(54) CONTACTLESS CHARGING APPARATUS, CONTACTLESS CHARGING BATTERY APPARATUS, AND CONTACTLESS CHARGING SYSTEM INCLUDING SAME

(76) Inventor: Jun ll Kim, Seoul (KR)

(21) Appl. No.: 13/496,136

(22) PCT Filed: Jan. 15, 2010
(86) PCT No.: PCT/KR10/00278

§ 371 Date: Mar. 14, 2012

(30) Foreign Application Priority Data
Sep. 15, 2009 (KR) 10-2009-0086999

(51) Int. Cl. H02J 7/00

(52) U.S. Cl. 320/108

(57) ABSTRACT

Provided are a contactless charging apparatus, a contactless charging battery apparatus, and a contactless charging system including same. According to one embodiment of the present invention, a contactless charging apparatus for charging a contactless charging battery apparatus comprises: a first coil unit including a plurality of coils; a charge control unit for determining a charging power corresponding to the contactless charging battery apparatus; and a power distribution unit for selecting one or more coils from the plurality of coils in accordance with the charging power, wherein the charging power is the power required for charging the contactless charging battery apparatus.

### BACKGROUND OF THE INVENTION

1. Technical Field

The present invention relates to a contactless charging apparatus, more specifically to a contactless charging apparatus, a contactless charging battery apparatus for charging electric power using the contactless charging apparatus, and a contactless charging system including the contactless charging apparatus.

2. Background Art

User terminals, such as personal computers, for example, notebooks and netbooks, mobile communication terminals and personal digital assistants (PDA), are installed with a battery (i.e., a secondary battery) that is rechargeable and for supplying electric power to a printed circuit board (PCB) installed in the main body of the user terminal.

Charging the battery requires a separate charging apparatus that supplies electric energy to the batter of the user terminal using residential electric power. The battery is has contact terminals that are exposed to an outside so as to be electrically connected to charging terminals arranged in the charging apparatus. While the battery is charged, the charging terminals of the charging apparatus are connected with the contact terminals of the battery to maintain electrical connection.

However, in this type of contact charging method, the charging terminals of the charging apparatus and the contact terminals of the battery are exposed to the outside for contact with one another and thus are easily contaminated, and friction between the two terminals during the contact between the charging terminals and the contact terminals causes abrasion to the terminals. Moreover, the moisture in the air corrodes the charging terminals and the contact terminals, deteriorating the contact between the charging terminals and the contact terminals.

In addition, in the contact charging method, the moisture can penetrate into the battery through minute gaps of the contact terminals while the battery is used, causing short-circuit in the e internal circuit that can deteriorate the life and performance of the charging apparatus and the battery or even completely discharging the battery.

Suggested recently to solve these problems is a contactless charging method, in which the battery is charged without making contact with the charging apparatus. In this contactless charging method, the charging apparatus has a first coil and the battery has a second coil, and the user terminal is charged by the induction between the first coil and the second coil when the battery approaches the charging apparatus.

However, the conventional contactless charging method requires that different charging apparatuses be used different user terminals, respectively, in which the input voltage, current and power is different. Accordingly, a user has had to purchase a separate contactless charging apparatus for each and every user terminal.

Furthermore, the conventional contactless charging method requires that a high-power coil be driven even if a low-power user terminal is charged, wasting the electric power.

### SUMMARY OF THE INVENTION

An embodiment of the present invention provides a contactless charging apparatus, a contactless charging battery apparatus and a contactless charging system including the same that can commonly charge user terminals that have different input voltages, currents and powers.

Moreover, an embodiment of the present invention provides a contactless charging apparatus, a contactless charging battery apparatus and a contactless charging system including the same that can only drive a coil corresponding to the power of the user terminal among a plurality of coils.

An aspect of the present invention features a contactless charging apparatus for charging a contactless charging battery apparatus.

An embodiment of the present invention provides a contactless charging apparatus for charging a contactless charging battery apparatus that includes: a first coil unit, comprising a plurality of coils; a charging control unit, configured to determine charging power corresponding to the contactless charging battery apparatus; and a power distribution unit, configured to select one or more coils among the plurality of coils according to the charging power. The charging power can be electric power required for charging the contactless charging battery apparatus.

The first coil unit can be arranged with the plurality of coils, of which the size of respective hollow portions becomes gradually smaller, inside an outermost coil of the plurality of coils, and the outermost coil can be a coil that is arranged on an outermost side of the plurality of coils.

The first coil unit can include the plurality of coils that have a same center of gravity and a different size of respective hollow portions.

The plurality of coils of the first coil unit can generate respective magnetic fields that are different from one another.

The power distribution unit can select one or more coils of the plurality of coils corresponding to the charging power and distribute driving power to the selected coil in order to drive the selected coil.

The contactless charging apparatus can also include a coil driving unit that includes a plurality of coil driving circuits corresponding to the plurality of coils, respectively.

The coil driving circuit corresponding to the coil selected by the power distribution unit can use the driving power provided by the power distribution unit to drive the selected coil.

The coil can include a hollow portion in a form selected from the group consisting of a circle, an oval and a polygon.

An aspect of the present invention features a contactless charging battery apparatus for charging by use of a contactless charging apparatus.

An embodiment of the present invention provides a contactless charging battery apparatus for charging by use of a contactless charging apparatus that includes: a battery which is rechargeable; a battery control unit, configured to generate charging power data by determining charging power for charging the battery and to transmit the charging power data to the contactless charging apparatus; and a second coil unit coupled magnetically with the contactless charging apparatus and configured to generate induced electromotive force by the contactless charging apparatus. The charging power can be electric power required for charging the battery and can correspond to the charging power data.

The contactless charging battery apparatus can also include: a rectifier configured to rectify an AC power of the induced electromotive force to a DC power;

a voltage/current regulation unit configured to generate constant voltage and constant current to charge the battery by using the DC power; and a charging regulation unit configured to regulate a charging status of the battery.

An aspect of the present invention features a contactless charging system including a contactless charging apparatus and a contactless charging battery apparatus.

An embodiment of the present invention provides a contactless charging system comprising a contactless charging apparatus and a contactless charging battery apparatus that includes: a contactless charging apparatus comprising a first coil unit constituted with a plurality of coils and configured to determine a charging power to charge the contactless charging battery by using charging power data received from the contactless charging battery apparatus and to select one or more coils of the plurality of coils according to the charging power; and a contactless charging battery apparatus, configured to generate the charging power data by using the charging power for charging the battery and comprising a second coil unit configured to generate induced electromotive force by magnetic field generated by the first coil unit.

In the first coil unit, an (n+1)th coil of the plurality of plurality of coils can be formed to surround an outline of an nth coil, and the plurality of coils can be formed to be separated from one another, n being a natural number.

The plurality of coils of the first coil unit can generate respective magnetic fields that are different from one another, and the (n+1)th coil can generate a greater magnetic field than the nth coil.

Each of the plurality of coils can be formed by winding a coil were at least once, and the (n+1)th coil can generate a magnetic field that is a same size as the (n+1)th coil according to a number of winding of the coil wire.

Each of the plurality of coils can be formed by winding a coil were at least once, and the plurality of coils of the first coil unit can respectively generate different sizes of magnetic field according to numbers of winding of the coil wire.

The contactless charging apparatus can select one or more coils of the plurality of coils to correspond to the charging power and can also include a power distribution unit for distributing driving power to the selected coil in order to drive the selected coil.

The contactless charging system can also include a coil driving unit that includes a plurality of coil driving circuits corresponding to the plurality of coils, respectively, and the coil driving circuit corresponding to the coil selected by the power distribution unit can drive the selected coil by using the driving power provided by the power distribution unit.

The contactless charging apparatus can also include a charging control unit configured to determine charging power to charge the contactless charging battery apparatus by using the charging power data received through a receiving unit from the contactless charging battery apparatus and to provide the charging power to the power distribution unit, and the contactless charging battery apparatus can also include a battery control unit configured to generate the charging power data by determining charging power for charging the battery and to transmit the charging power data to the contactless charging apparatus through a transmitting unit.

The contactless charging apparatus, the contactless charging battery apparatus and the contactless charging system including the same in accordance with an embodiment of the present invention can commonly charge user terminals that have different input voltages, currents and powers.

The contactless charging apparatus, the contactless charging battery apparatus and the contactless charging system including the same in accordance with an embodiment of the present invention can also supply the electric power according to the power of the user terminal.

Moreover, the contactless charging apparatus, the contactless charging battery apparatus and the contactless charging system including the same in accordance with an embodiment of the present invention only drive a coil corresponding to the power of the user terminal among a plurality of coils, efficiently utilizing the power consumption.

### BRIEF DESCRIPTION OF THE DRAWINGS

FIG. 1 is a brief illustration of a contactless charging system in accordance with an embodiment of the present invention.

FIG. 2 is a block diagram showing details of the contactless charging system of FIG. 1.

FIG. 3 illustrates a first coil unit of a contactless charging apparatus in accordance with an embodiment of the present invention.

FIG. 4 illustrates a first coil unit of a contactless charging apparatus in accordance with another embodiment of the present invention.

FIG. 5 illustrates a first coil unit of a contactless charging apparatus in accordance with yet another embodiment of the present invention.

FIG. 6 is a flow diagram briefly illustrating a contactless charging method in accordance with an embodiment of the present invention.

FIG. 7 is a flow diagram illustrating how the contactless charging apparatus carries out the contactless charging method in accordance with an embodiment of the present invention.

FIG. 8 is a flow diagram illustrating how a contactless charging battery apparatus carries out the contactless charging method in accordance with an embodiment of the present invention.

### DETAILED DESCRIPTION OF THE INVENTION

Since there can be a variety of permutations and embodiments of the present invention, certain embodiments will be illustrated and described with reference to the accompanying drawings.

This, however, is by no means to restrict the present invention to certain embodiments, and shall be construed as including all permutations, equivalents and substitutes covered by the ideas and scope of the present invention. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, a contactless charging apparatus, a contactless charging battery apparatus and a contactless charging system including the same in accordance with the present invention will be described in detail with reference to the accompanying drawings. Identical or corresponding elements will be given the same reference numerals, regardless of the figure number, and any redundant description of the identical or corresponding elements will not be repeated.

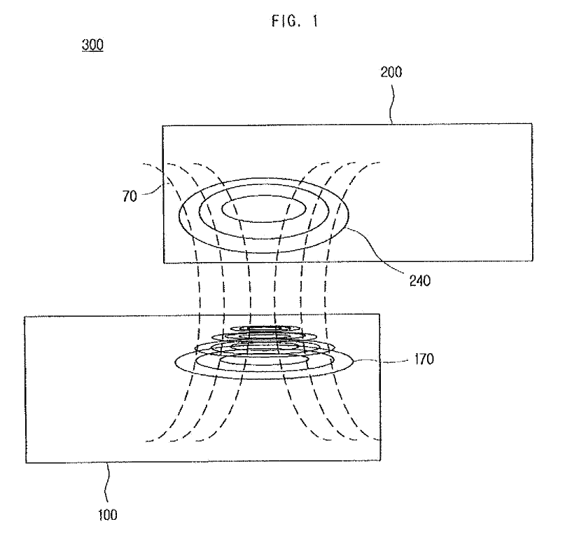

A contactless charging system in accordance with the present invention will be briefly described with reference to FIG. 1. FIG. 1 is a brief illustration of a contactless charging system in accordance with an embodiment of the present invention.

Referring to FIG. 1, a contactless charging system 300 includes a contactless charging apparatus 100 and a contactless charging battery apparatus 200.

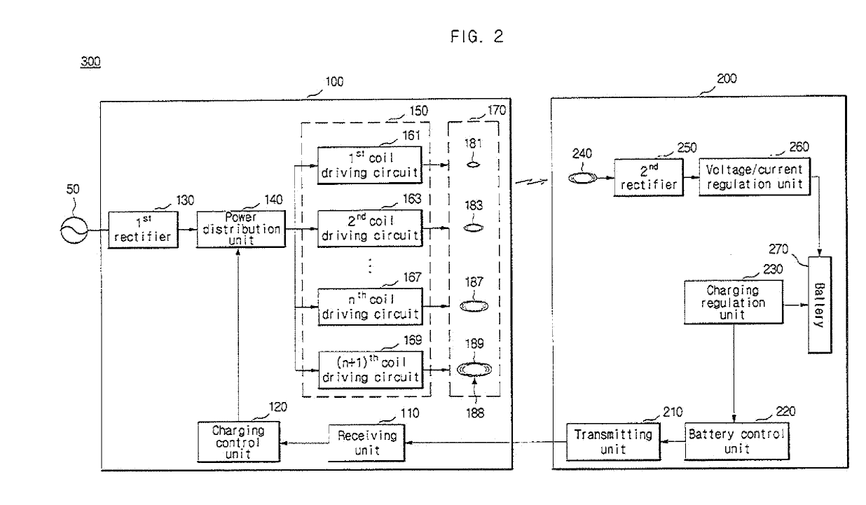

The contactless charging apparatus 100 is supplied with electric energy from an outside power source 50 and generates electric power to be supplied to the contactless charging battery apparatus 200. Here, the outside power source 50 can be preferably a residential AC power (e.g., 110V˜220V) and can be another DC power. Moreover, it is preferable that a surface of the contactless charging apparatus 100 that makes contact with the contactless charging battery apparatus 200 is formed to be flat for easier contact with the contactless charging battery apparatus 200. The contactless charging apparatus 100 will be described in detail with reference to FIG. 2.

The contactless charging battery apparatus 200 is supplied with electric power by using a first coil unit 170 of the contactless charging apparatus 100. Specifically, a second coil unit 240 of the contactless charging battery apparatus 200 is organically coupled with the first coil unit 170 and generates induced electromotive force by magnetic field 70 of the first coil unit 170. The contactless charging battery apparatus 200 charges a battery 270 by using the induced electromotive force.

Any kind of apparatus can be the contactless charging battery apparatus 200 as long as it can be supplied with power by using the battery 270. For example, the contactless charging battery apparatus 200 can be a mobile communication terminal, in which communication functionality can be included, a computer, such as a desktop computer, a notebook computer and a netbook, a PDA (Personal Digital Assistant), a PMP (Portable Multimedia Player), which can output music, image and video, and a digital electronic dictionary. Here, the mobile communication terminal can be a device in which communication functionality can be included, for example, a PDC (Personal Digital Cellular) phone, a PCS (Personal Communication Service) phone, PHS (Personal Handyphone System) phone, a CDMAΔ2000 (1×, 3×) phone, a WCDMA (Wideband CDMA) phone, a Dual Band/Dual Mode phone, a GSM (Global Standard for Mobile) phone, an MBS (Mobile Broadband System) phone, a DMB (Digital Multimedia Broadcasting) phone and a smart phone.

The contactless charging battery apparatus 200 will be described in more detail with reference to FIG. 2.

The contactless charging system in accordance with the present invention will be described in detail with reference to FIG. 2. FIG. 2 is a block diagram showing details of the contactless charging system of FIG. 1.

Referring to FIG. 2, the contactless charging system 300 includes the contactless charging apparatus 100 and the contactless charging battery apparatus 200.

The contactless charging apparatus 100 includes a receiving unit 110, a charging control unit 120, a first rectifier 130, a power distribution unit 140, a coil driving unit 150 and the first coil unit 170.

The receiving unit 110 receives charging power data from the contactless charging battery apparatus 200. The receiving unit 110 can receive the charging power data from the contactless charging battery apparatus 200 through a wireless communication method, such as RF (Radio Frequency) communication and Zigbee. Moreover, the receiving unit 110 can receive battery data that includes the status of the battery 270 from the contactless charging battery apparatus 200.

The charging control unit 120 determines a charging power corresponding to the contactless charging battery apparatus 200. Specifically, the charging control unit 120 determines the charging power corresponding to the contactless charging battery apparatus 200 by using the charging power data received from the contactless charging battery apparatus 200 through the receiving unit 110. Here, the charging power is electric power required for charging the battery 270 of the contactless charging battery apparatus 200.

The first rectifier 130 rectifies AC power provided from the residential AC power, which is the outside power source 50, to a driving power, which is DC power. Here, the driving power is electric power for driving a coil.

The power distribution unit 140 determines the coil to be driven depending on the contactless charging battery apparatus 200. Specifically, the power distribution unit 140 determines the coil in the first coil unit 170 so as to correspond to the charging power determined by the charging control unit 120. Here, the power distribution unit 140 can select one or more coils in order to correspond to the charging power. As the coils are determined to correspond to the contactless charging battery apparatus 200, different contactless charging battery apparatus 200 having different charging power can be charged using one contactless charging apparatus 100.

The power distribution unit 140 is arranged between the first rectifier 130 and the coil driving unit 150 and distributes the driving power to one or more coil driving circuits 161, 163, 167, 169 (collectively 160) corresponding to one or more of the coils 181, 183, 187, 189 (collectively 180) that are determined to correspond to the contactless charging battery apparatus 200.

The coil driving unit 150 includes a plurality of coil driving circuits 160. The plurality of coil driving circuits 160 correspond to the plurality of coils 180 of the first coil unit 170. In other words, each of the plurality of coil driving circuits 160 corresponds one-to-one to each of the plurality of coils 180. The driving circuit 160 to which the driving power is distributed drives the coil 180 using the driving power.

The first coil unit 170 includes the plurality of coils 180. The first coil unit 170 is driven by the coil driving unit 150, and generates a magnetic field when it makes

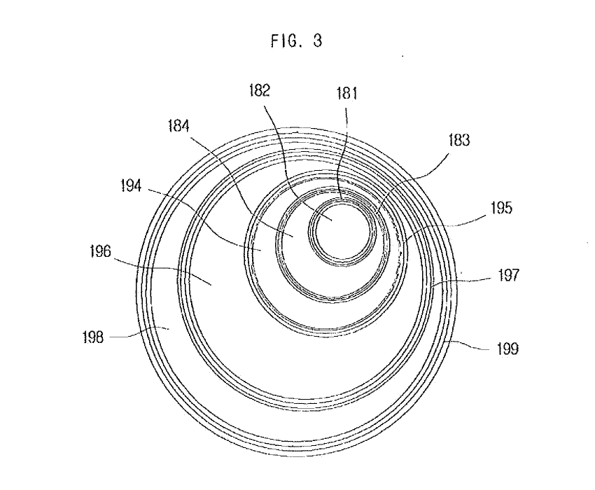

contact with the second coil unit 240. Here, the magnetic field is electric power that is generated by the first coil unit 170 and transferred to the second coil unit 240. The plurality of coils 180 generate either the same magnitude of magnetic field or different magnitudes of magnetic field, depending on the numbers of winding of coil wire 188. Specifically, if every one of the plurality of coils 180 in the first coil unit 170 is wound by the coil wire 188 in the same number of times, the generated magnetic field becomes bigger from a first coil 181 to an (n+1)th coil 188. On the other hand, if a second coil 183 of the first coil unit 170 is wound by the coil wire 188 in a fewer number of times than the first coil 181, the magnitudes of magnetic field generated by the first coil 181 and the second coil 183 can be the same. The first coil unit 170 will be described in more detail with reference to FIGS. 3 to 5.

The contactless charging battery apparatus 200 includes a transmitting unit 210, a battery control unit 220, a charging regulation unit 230, the second coil unit 240, a second rectifier 250, a voltage/current regulation unit 260, and the battery 270.

The transmitting unit 210 transmits the charging power data to the contactless charging apparatus 100. The transmitting unit 210 can transmit the charging power data to the contactless charging apparatus through a wireless communication method, such as RF communication and Zigbee.

Moreover, the transmitting unit 210 can transmit battery data generated by the battery control unit 220 to the contactless charging apparatus 100.

The battery control unit 220 generates the charging power data for transmitting to the contactless charging apparatus 100 by determining the electric power that can charge the battery 270.

The battery control unit 220 controls the transmitting unit 210 in order to transmit the charging power data to the contactless charging apparatus 100.

Moreover, the battery control unit 220 can generate the battery data by assessing initial status information and status change information of the battery 270 provided by the charging regulation unit 230. The battery control unit 220 controls the transmitting unit 210 in order to transmit the battery data to the contactless charging apparatus 100.

The charging regulation unit 230 is connected with the battery 270, and assesses an initial status of the battery to generate the initial status information and assesses a changing status of the battery 270 to generate the status change information. The charging regulation unit 230 provides the initial status information and the status change information to the battery control unit 220.

The second coil unit 240 is magnetically coupled with the first coil unit 170 of the contactless charging apparatus 100 to generate the induced electromotive force. Since the magnetic field generated by the first coil unit 170 is an AC power, the induced electromotive force is also an AC power.

The second rectifier 250 is connected to an output portion of the second coil unit 240 and rectifies the AC power of the induced electromotive force generated by the second coil unit 240 to a DC power.

The voltage/current regulation unit 260 uses the DC power rectified by the second rectifier 250 to generate constant voltage and constant current to be charged to the battery 270. More specifically, constant current is maintained if the battery 270 is charged during the initial stage, but it is switched over to constant voltage if the battery 270 is charged in saturation.

The battery 270 supplies power to the contactless charging battery apparatus 200.

The battery is charged using the constant voltage and the constant current generated by the voltage/current regulation unit 260. It is preferable that the battery 270 is constituted with rechargeable electric cells, for example, lithium ion electric cells or lithium polymer electric cells.

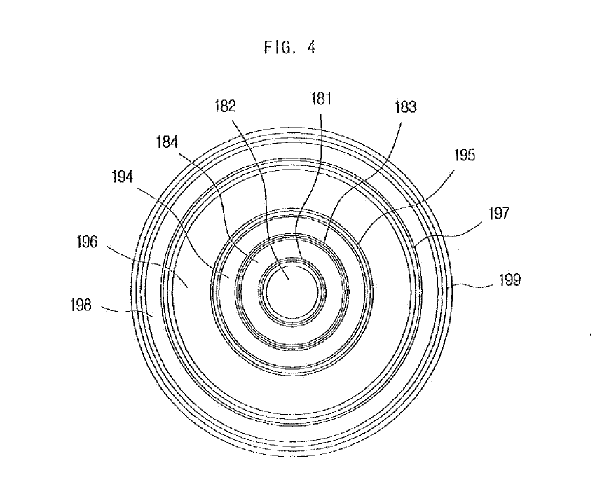

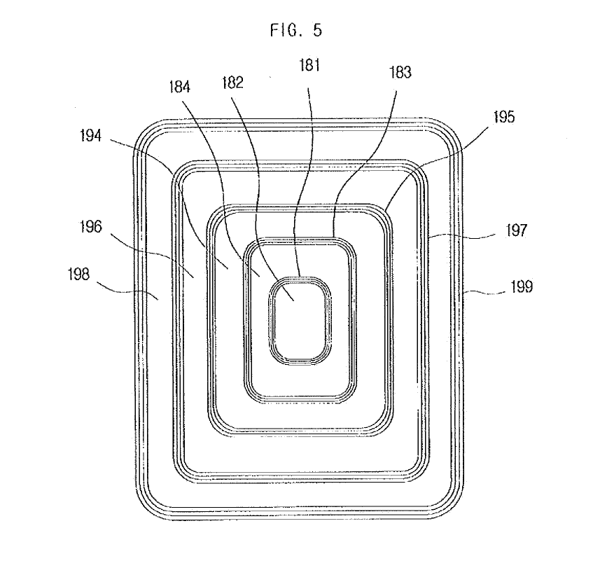

The first coil unit in accordance with the present invention will be described with reference to FIGS. 3 to 5. FIG. 3 illustrates the first coil unit of the contactless charging apparatus in accordance with an embodiment of the present invention. FIG. 4 illustrates a first coil unit of a contactless charging apparatus in accordance with another embodiment of the present invention. FIG. 5 illustrates a first coil unit of a contactless charging apparatus in accordance with yet another embodiment of the present invention.

The first coil unit 170 is formed with the plurality of coils 180, as illustrated in FIG. 3.

Here, each of the plurality of coils 180 is formed in a circular shape and is formed by winding the coil wire 188 at least once. For example, each of the plurality of coils 180 can be formed by winding the coil wire 188 four times. Although the coil wire 188 is wound the same number of times, the present invention is not restricted to this, and it is possible that each of the plurality of coils 180 is formed by winding the coil wire 188 a different number of times.

The first coil unit 170 includes the plurality of coils 180 having different sizes of hollow portions 182, 184, 194, 196, 198 (collectively 190), respectively. Here, the hollow portions 190 can be holes formed by the coils 180. In the first coil unit 170, the plurality of coils 180, of which the size of the respective hollow portions 190 becomes gradually smaller, are arranged inside an outermost coil of the plurality of coils 180. Here, the outermost coil, which is the coil that is arranged on an outermost side of the plurality of coils, can be, for example, a fifth coil 199. In other words, in the first coil unit 170, a fourth coil 197 to the first coil 181, of which the size of the respective hollow portions 190 becomes gradually smaller, are arranged inside a hollow portion 198 of the fifth coil 199.

A second coil 183 of the first coil unit 170 is formed to surround an outline of the first coil 181, and the plurality of coils 180 are separated from one another.

Specifically, in the first coil unit 170, the first coil 181, of which the radius of a first hollow portion 182 is the smallest, is formed on an innermost side, and a second coil 183 is formed on an outside of the first coil 181. In addition, a third coil 195 and the fourth coil 197 are successively formed on an outside of the second coil 183, and the fifth coil 199, of which the radius of a fifth hollow portion 198 is the greatest, is formed on the outermost side.

The coils 180 are formed inside another coil 180, as described above, in order to prevent interference between the coils 180.

The first coil unit 170 generates magnetic fields that are different from one another. Specifically, the second coil 183 generates a greater magnetic field than the first coil 181. Accordingly, the fifth coil 199, which is formed on the outermost side, generates the greatest magnetic field. In addition, the plurality of coils 180 can be formed with different heights from one another in order to generate different magnitudes of magnetic field.

Although not illustrated in FIG. 3, it is possible in the first coil unit 170 that the same magnitude of magnetic field is generated by differentiating the number of winding the coil wire 188 even if the size of the hollow portions 190 is different from one another. For example, by winding the coil wire 188 four times on the first coil 181 and winding the coil wire 188 twice on the second coil 183, it becomes possible that the first coil 181 generates 2W of magnetic field and the second coil 183 generates 2W of magnetic field.

As illustrated in FIG. 4, the first coil unit 170 can include a plurality of circularly-formed coils, of which the size of the respective hollow portions 182, 184, 194, 196, 198 (collectively 190) is different from one another. The plurality of coils in the first coil unit 170 have the same center of gravity and have greater radii of the hollow portions 190 toward an outside. Specifically, in the first coil unit 170, the radius of the hollow portion 182 of the first coil 181 is greater than that of the hollow portion 184 of the second coil 183, and the radius of the hollow portion 196 of the fourth coil 197 is greater than that of the hollow portion 198 of the fifth coil 199.

As illustrated in FIG. 5, the first coil unit 170 can include a plurality of coils that are formed in rectangular shapes. Here, the plurality of coils 180 have the same center of gravity and have radii of the hollow portions 182, 184, 194, 196, 198 (collectively 190) that increase from the first coil 181 to the fifth coil 199. Specifically, in the first coil unit 170, diagonal lengths increase from the first coil 181 to the fifth coil 199. Although not illustrated in FIG. 5, it is also possible that a plurality of rectangular-shaped coils 180 having different centers of gravity from one another can be formed.

Although it is described with reference to FIGS. 3 to 5 that the plurality of coils 180 in the first coil unit 170 have circular and rectangular shapes, the present invention is not restricted to the shapes described herein as long as the shape can be formed by winding a coil. For example, the hollow portions 190 of the coil 180 can be any shape, such as a polygon (e.g., a triangle, a pentagon, a star, etc.) and an oval, which can increase the cross-sectional area.

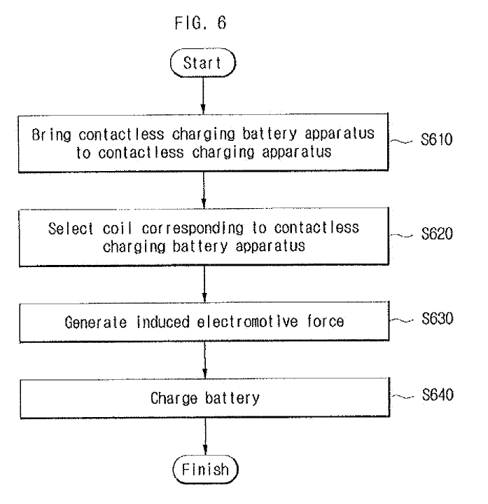

FIG. 6 is a flow diagram briefly illustrating a contactless charging method in accordance with an embodiment of the present invention.

Referring to FIG. 6, the contactless charging battery apparatus 200 comes in contact with the contactless charging apparatus 100 (S610). That is, the contactless charging battery apparatus 200 accesses the contactless charging apparatus 100 in order to charge the battery 270 of the contactless charging battery apparatus 200. Here, it is preferable that the second coil unit 240 of the contactless charging battery apparatus 200 and the first coil unit 170 of the contactless charging apparatus 100 are formed to face each other.

The contactless charging apparatus 100 selects the coil 180 corresponding to the contactless charging battery apparatus 200 (S620). The contactless charging apparatus 100 uses the charging power data received from the contactless charging battery apparatus 200 to determine the charging power corresponding to the contactless charging battery apparatus 200. Then the contactless charging apparatus 100 selects the coil 180 corresponding to the charging power among the plurality of coils 180 in the first coil unit 170. Here, the contactless charging apparatus can select one or more coils 180.

The contactless charging battery apparatus 200 generates induced electromotive force by the contactless charging apparatus 100 (S630). Specifically, the second coil unit 240 of the contactless charging battery apparatus 200 generates the induced electromotive force by the magnetic field generated by the coil 180 of the first coil unit 170 corresponding to the charging power.

The contactless charging battery apparatus 200 charges the battery 270 (S640). The contactless charging battery apparatus 200 uses the induced electromotive force generated by the second coil unit 240 to charge the battery. Accordingly, as the contactless charging battery apparatus 200 can charge the battery 270 by using the contactless charging apparatus 100, it becomes possible to solve the problems caused by abrasion or corrosion by moisture in contact terminals of the battery 270 and charging apparatuses.

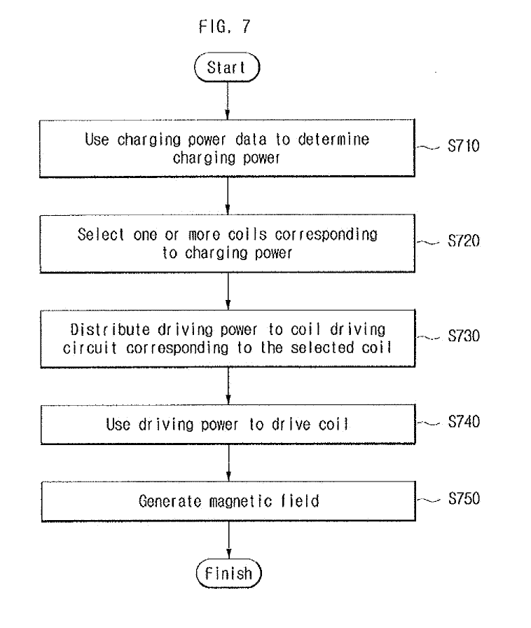

FIG. 7 is a flow diagram illustrating how the contactless charging apparatus carries out the contactless charging method in accordance with an embodiment of the present invention.

Referring to FIG. 7, the contactless charging apparatus 100 uses the charging power data to determine the charging power (S710). Specifically, once the contactless charging battery apparatus 200 makes contact with the contactless charging apparatus 100, the receiving unit 110 of the contactless charging apparatus 100 receives the charging power data from the contactless charging battery apparatus 200, and the charging control unit 120 uses the charging power data provided by the receiving unit 110 to determine the charging power to be used for charging in the contactless charging battery apparatus 200.

The contactless charging apparatus 100 selects one or more coils 180 corresponding to the charging power (S720). Specifically, the power distribution unit 140 of the contactless charging apparatus 100 is provided with the charging power from the charging control unit 120, and then the power distribution unit 140 selects the coil 180 corresponding to the charging power among the plurality of coils 180 included in the first coil unit 170. For example, if the first coil 181 generates 5W of magnetic field, the second coil 183 and the third coil generating 10W and 15W of magnetic field, respectively, and the charging control unit 120 uses the charging power data to determine 5W of charging power, the power distribution unit 140 selects the coil corresponding to 5W, using the charging power of 5W.

In other words, the power distribution unit 140 selects the first coil.

Meanwhile, the power distribution unit 140 can select one or more coils. For example, if the first coil 181 generates 2W of magnetic field, the second coil 183 and the third coil generating 3W and 6W of magnetic field, respectively, and the charging control unit 120 uses the charging power data to determine 5W of charging power, the power distribution unit 140 selects the coils corresponding to 5W, using the charging power of 5W. That is, the power distribution emit 140 selects the first coil 181 and the second coil 183. In another example, if the first coil 181 generates 2W of magnetic field, the second coil 183 and the third coil generating 2W and 6W of magnetic field, respectively, and the power control unit 120 uses the charging power data to determine 4W of charging power, the power distribution unit 140 selects the coils corresponding to 4W, using the charging power of 4W.

In other words, the power distribution unit 140 selects the first coil 181 and the second coil 183.

The contactless charging apparatus 100 distributes the driving power to the coil driving circuit 160 corresponding to the selected coil 180 (S730). Specifically, the rectifier of the contactless charging apparatus 100 rectifies the AC power provided from the residential AC power, which is the outside power source 50, to the driving power, which is a DC power, and provides this driving power to the power distribution unit 140.

Then, the power distribution unit 140 distributes the driving power to the coil driving circuit 160 corresponding to the selected coil 180 in order to drive the coil 180. For example, the power distribution unit 140 distributes a first coil driving circuit 161 and a second coil driving circuit 163 in order to generate the magnetic field corresponding to the charging power.

Although it is described herein that the step of rectifying an AC power to a DC power occurs after the step of selecting the coil 180 to drive, the present invention is not restricted to the above, and the order of the steps may be changed as long as the steps occur before the power distribution unit 140 distributes the driving power to the coil driving unit 150.

The contactless charging apparatus 100 uses the driving power to drive the coil 180 (S740).

Specifically, the coil driving circuit 160 to which the driving power is distributed in the coil driving unit 150 of the contactless charging apparatus 100 uses the driving power to drive the coil 180. For example, the first coil driving circuit 161 and the second coil driving circuit 163, to which the driving power is distributed, drive the first coil 181 and the second coil 183, respectively.

The contactless charging apparatus 100 generates the magnetic field (S750). In other words, the first coil unit 170 of the contactless charging apparatus 100 is organically coupled with the second coil unit 240 of the contactless charging battery apparatus 200 to generate the magnetic field. Accordingly, as the contactless charging apparatus 100 has the plurality of coils 180 that generate different magnitudes of magnetic field, the contactless charging apparatus 100 can charge the contactless charging battery apparatuses 200 of which the charging power is different from one another, and it becomes possible to efficiently utilize the power consumption because the coil(s) 180 corresponding to the charging power according to the contactless charging battery apparatus 200 is/are driven.

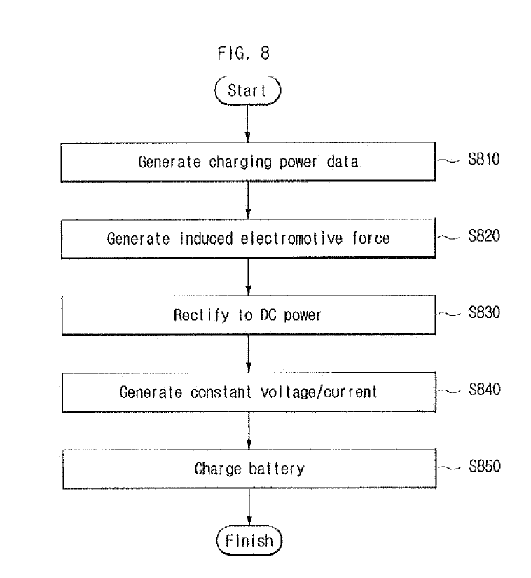

FIG. 8 is a flow diagram illustrating how the contactless charging battery apparatus carries out the contactless charging method in accordance with an embodiment of the present invention.

Referring to FIG. 8, the contactless charging battery apparatus 200 generates the charging power data (S810). Specifically, the battery control unit 220 of the contactless charging battery apparatus 200 determines the charging power for charging the battery 270. Then, the battery control unit 220 uses the charging power to generate the charging power date to be transmitted to the contactless charging apparatus 100. The battery control unit controls the transmitting unit 210 to transmit the charging power data to the contactless charging apparatus 100.

The contactless charging battery apparatus 200 generates the induced electromotive force by the contactless charging apparatus 100 (S820). Specifically, the second coil unit 240 of the contactless charging battery apparatus 200 is magnetically coupled with the first coil unit 170 of the contactless charging apparatus 100 and generated the induced electromotive force by the magnetic field generated by the first coil unit 170. Here, the first coil unit 170 is the coil 180 corresponding to the charging power of the contactless charging battery apparatus 200 and generates the magnetic field corresponding to the charging power required by the battery 270 for charging.

The contactless charging battery apparatus 200 rectifies the induced electromotive force to a DC power (S830). In other words, the first rectifier 130 of the contactless charging battery apparatus 200 rectifies the induced electromotive force of the AC power generated by the second coil unit 240 to a certain level of DC power.

The contactless charging battery apparatus 200 uses the DC power to generate constant voltage/current (S840). Specifically, the voltage/current regulation unit 260 of the contactless charging battery apparatus 200 uses the DC power rectified by the first rectifier 130 to generate constant voltage and constant current to be charged in the battery 270.

The contactless charging battery apparatus 200 uses the constant voltage/current to charge the battery 270 (S850). Specifically, the battery 270 of the contactless charging battery apparatus 200 is charged using the constant current generated by the voltage/current regulation unit 260, and once the charging voltage is saturated, it is converted to constant voltage.

Although certain embodiments of the present invention have been described, it shall be appreciated that there can be a variety of modifications and permutations by those of ordinarily skilled in the art to which the present invention pertains without departing from the technical ideas and scopes of the present invention that shall be defined by the claims appended below.

What is claimed is:

1. A contactless charging apparatus for charging a contactless charging battery apparatus, comprising:
a first coil unit, comprising a plurality of coils;
a charging control unit, configured to determine charging power corresponding to the contactless charging battery apparatus; and
a power distribution unit, configured to select one or more coils among the plurality of coils according to the charging power,
wherein the charging power is electric power required for charging the contactless charging battery apparatus.

2. The contactless charging apparatus of claim 1, wherein the first coil unit is arranged with the plurality of coils, of which the size of respective hollow portions becomes gradually smaller, inside all outermost coil of the plurality of coils, and
wherein the outermost coil is a coil that is arranged on an outermost side of the plurality of coils.

3. The contactless charging apparatus of claim 1 or 2, wherein the first coil unit comprises the plurality of coils that have a same center of gravity and a different size of respective hollow portions.

4. The contactless charging apparatus of claim 1, wherein the plurality of coils of the first coil unit generate respective magnetic fields that are different from one another.

5. The contactless charging apparatus of claim 1, wherein the power distribution unit selects one or more coils of the plurality of coils corresponding to the charging power and distributes driving power to the selected coil in order to drive the selected coil.

6. The contactless charging apparatus of claim 5, further comprising a coil driving unit that includes a plurality of coil driving circuits corresponding to the plurality of coils, respectively.

7. The contactless charging apparatus of claim 6, wherein the coil driving circuit corresponding to the coil selected by the power distribution unit uses the driving power provided by the power distribution unit to drive the selected coil.

8. The contactless charging apparatus of claim 1, wherein the coil comprises a hollow portion in a form selected from the group consisting of a circle, an oval and a polygon.

9. A contactless charging battery apparatus for charging by use of a contactless charging apparatus, comprising:
a battery which is rechargeable;
a battery control unit, configured to generate charging power data by determining charging power for charging the battery and to transmit the charging power data to the contactless charging apparatus; and
a second coil unit coupled magnetically with the contactless charging apparatus and configured to generate induced electromotive force by the contactless charging apparatus,
wherein the charging power is electric power required for charging the battery and corresponds to the charging power data.

10. The contactless charging battery apparatus of claim 9, further comprising:
a rectifier configured to rectify an AC power of the induced electromotive force to a DC power;
a voltage/current regulation unit configured to generate constant voltage and constant current to charge the battery by using the DC power; and
a charging regulation unit configured to regulate a charging status of the battery.

11. A contactless charging system comprising a contactless charging apparatus and a contactless charging battery apparatus, the contactless charging system comprising:
a contactless charging apparatus comprising a first coil unit constituted with a plurality of coils and configured to determine a charging power to charge the contactless charging battery by using charging power data received from the contactless charging battery apparatus and to select one or more coils of the plurality of coils according to the charging power; and
a contactless charging battery apparatus, configured to generate the charging power data by using the charging power for charging the battery and comprising a second coil unit configured to generate induced electromotive force by magnetic field generated by the first coil unit.

12. The contactless charging system of claim 11, wherein, in the, first coil unit, an (n+1)th coil of the plurality of plurality of coils is formed to surround an outline of an n^{th} coil, and the plurality of coils are formed to be separated from one another, n being a natural number.

13. The contactless charging system of claim 12, wherein the plurality of coils of the first coil unit generate respective magnetic fields that are different from one another, and the (n+1)th coil generates a greater magnetic field than the n^{th} coil.

14. The contactless charging system of claim 12, wherein each of the plurality of coils is formed by winding a coil were at least once, and the (n+1)th coil generates a magnetic field that is a same size as the (n+1)th coil according to a number of winding of the coil wire.

15. The contactless charging system of claim 12, wherein each of the plurality of coils is formed by winding a coil were at least once, and the plurality of coils of the first coil unit respectively generate different sizes of magnetic field according to numbers of winding of the coil wire.

16. The contactless charging system of claim 11, wherein the contactless charging apparatus selects one or more coils of the plurality of coils to correspond to the charging power and further comprises a power distribution unit for distributing driving power to the selected coil in order to drive the selected coil.

17. The contactless charging system of claim 16, wherein the contactless charging system further comprises a coil driving unit that includes a plurality of coil driving circuits corresponding to the plurality of coils, respectively, and
wherein the coil driving circuit corresponding to the coil selected by the power distribution unit drives the selected coil by using the driving power provided by the power distribution unit.

18. The contactless charging system of claim 11, wherein the contactless charging apparatus further comprises a charging control unit configured to determine charging power to charge the contactless charging battery apparatus by using the charging power data received through a receiving unit from the contactless charging battery apparatus and to provide the charging power to the power distribution unit, and
wherein the contactless charging battery apparatus further comprises a battery control unit configured to generate the charging power data by determining charging power for charging the battery and to transmit the charging power data to the contactless charging apparatus through a transmitting unit.
